(19) United States
(12) Patent Application Publication
(10) Pub. No.: US 2018/0252030 A1
(43) Pub. Date: Sep. 6, 2018

(54) Fully Re-sizable and Re-mountable Window Shade

(71) Applicant: Brandon Scott Hernandez, Glendora, CA (US)

(72) Inventor: Brandon Scott Hernandez, Glendora, CA (US)

(21) Appl. No.: 15/448,027

(22) Filed: Mar. 2, 2017

(51) Int. Cl. E06B 9/322; E06B 9/262; E06B 9/323

(52) U.S. Cl. CPC E06B 9/322; E06B 9/323; E06B 9/262

(57) ABSTRACT

The invention is a window shade that can be easily mounted without the need of screws or installation of any mounting fixtures. Additionally, this window shade can be moved from one window to another window of different dimensions. Also, the product does not require the consumer to cut or destroy any parts of the window shade to move from a larger window to a smaller window. The shade can not only be moved from a larger window to a smaller window but can also be moved from a smaller window to a lager window.

### BACKGROUND OF THE INVENTION

The market for window shades is universally useful. Nearly every window requires some form of sunlight limitation and there are multiple windows in most rooms. When looking to limit sunlight one much go through a rather precise process to find a shade or blind which will properly fit the window frame. Additionally, once a consumer finds that shade they can only use it on window of the same size, or in some cases windows of a smaller size. There are some shades out there which can be resized to fit smaller windows by cutting the material and retrofitting the base but this only works on making the shade fit a smaller window not a larger window. This invention seeks to create a window shade that can fit a wide spectrum of window sizes and can be easily moved from one window to a larger or smaller window.

### BRIEF SUMMARY OF THE INVENTION

The invention is a window shade that can be easily mounted without the need of screws or installation of any mounting fixtures. Additionally, this window shade can be moved from one window to another window of different dimensions. Also, the product does not require the consumer to cut or destroy any parts of the window shade to move from a larger window to a smaller window. The shade can not only be moved from a larger window to a smaller window but can also be moved from a smaller window to a lager window.

### BRIEF SUMMARY OF THE SEVERAL VIEW OF THE DRAWING

FIG. 1A is a frontal view of the invention with the shades completely draw.

FIG. 1B is a frontal view of the invention where the shades are only half drawn.

FIG. 1C is an interior view of the shade mount and the key components.

FIG. 2A-E are various perspective drawings on the spring-loaded cushions attached to both ends of the shade mount.

FIG. 3 is of the overlapping shade material essential for resizing the shade.

FIG. 4 A&B are a magnified drawing of the drawstring lock slider.

FIG. 5 is a drawing of the adjustable side switch.

### DETAILED DESCRIPTION OF THE INVENTION

All explanations will be categorized by their respective figures and all parts referenced in the explanation will only use the part number after the first reference. (eg: First instance, “main frame 1”. Additional instances: “1”.)

This format seeks to concisely explain the attached drawings and may be ignored at times if a more through explanation is required. Lastly, the terms “unlocked” and “locked” will be used to reference the positional settings of the drawstring lock slider and adjustable side switch illustrated by “U” and “L”.

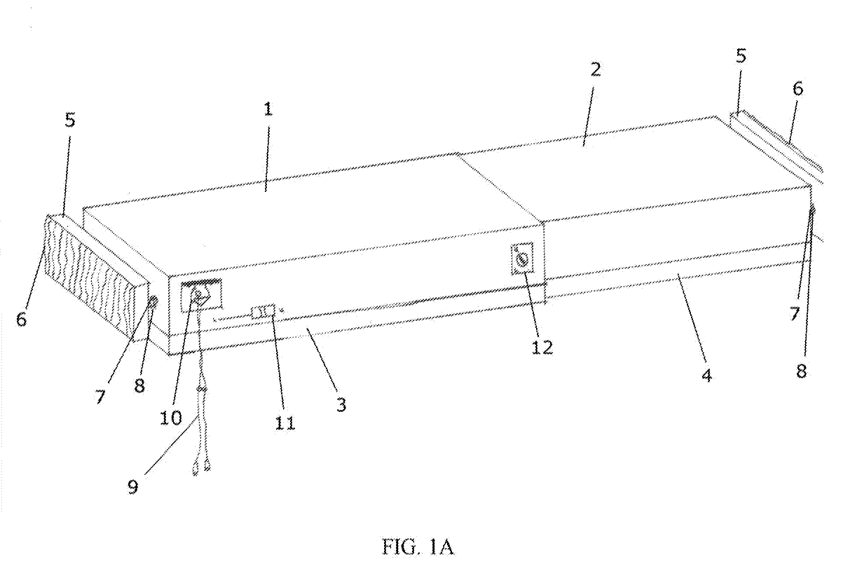

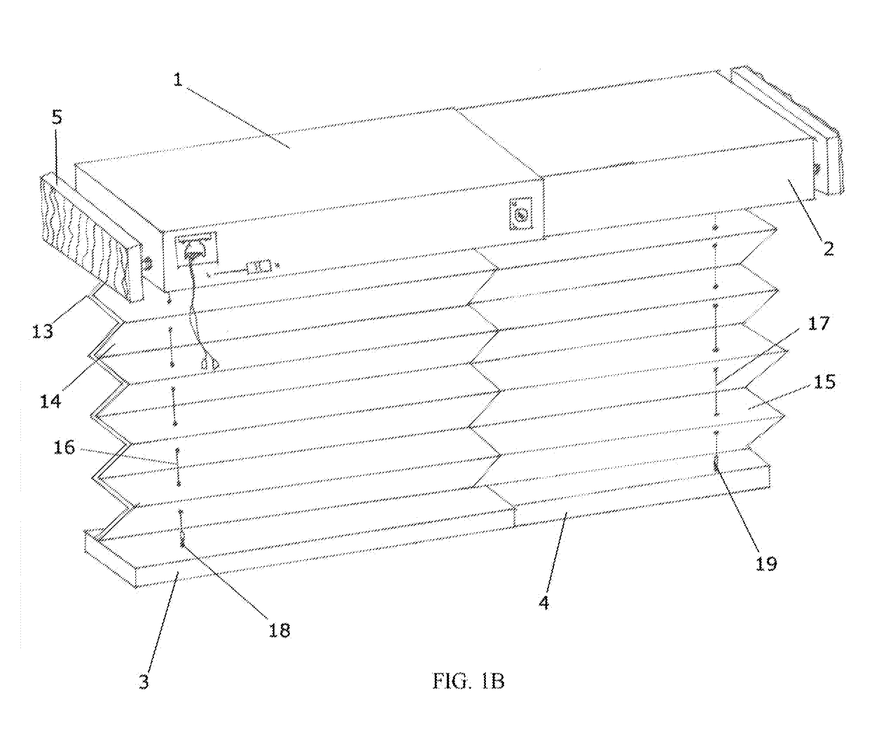

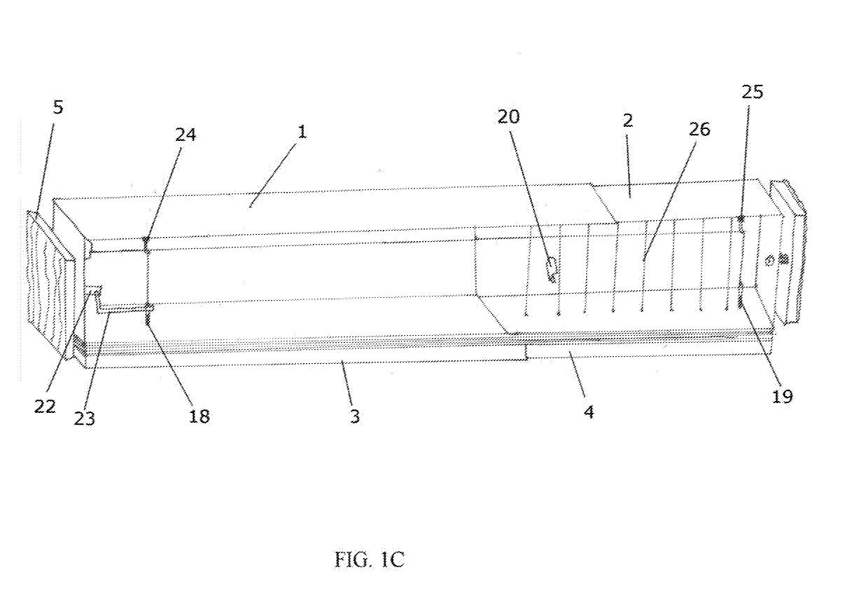

FIG. 1A: The shade mount contains an overlapping frame which consists of the main frame 1 and the sliding frame 2. Both frames have spring loaded cushions attached to them which are necessary for creating enough pressure to hold the shade mount against gravity without the need to screws. The cushions are composed of a cushion base 5, cushion padding 6, two cushion connectors 7 and two cushion springs 8 that wrap around 7. Additionally, the shade mount parts have respective shade bases which the material attaches to, these parts are main base 3 and movable base 4. Similar to 1 and 2, 3 and 4 also overlap with one another and are what make resizing the shade possible. Other major parts are the drawstring lock 10 which is a standard drawstring lock with a slight modification that allows it to be manually unlocked by the drawstring lock slider 11. Lastly, there is the adjustable side switch 12 which allows the consumer to rotate a blockade which depending on the setting allows a two-way needle to move one direction. Further explanation of said components will be in their respective drawings.

FIG. 1B: This drawing is of the invention where the drawstring is only half drawn. Various component parts are explained by the previous drawings so only new component parts will be explained. The shade material contains three separate shades overlapping each other: shade main one 13, shade main two 14 and shade side 15. The outer shades are 13 and 14 with 15 in-between. Essentially, 13 and 14 are fixed in place while 15 can move in and out thus allowing the shade to be resized. Also, two drawstrings are laced through 13, 14 and 15 allowing the shade length to be changed. String one 16 goes through the holes in 13 and 14 while string two 17 goes through 15. 16 and 17 are attached to string base main 18 and string base side 19 respectively. 18 and 19 are attached to 3 and 4 and this is what allows for the consumer to change the how far the wish to draw the shade.

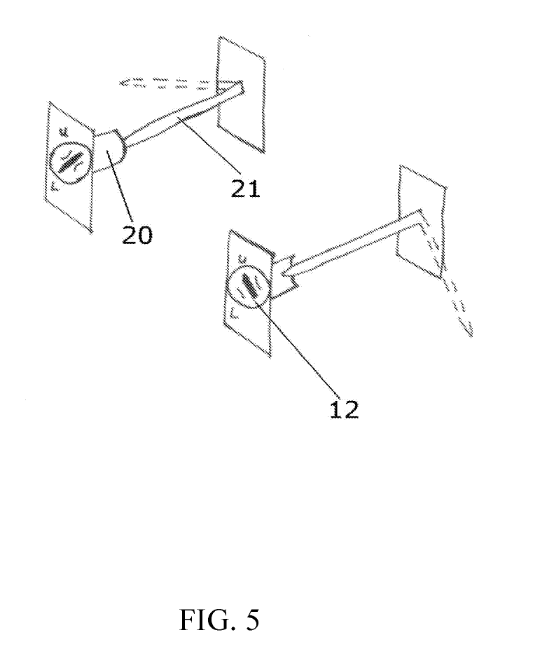

FIG. 1C: This drawing illustrates the interior of the invention. The first new component illustrated is the rotating block 20. This block will be further explained in FIG. 5. Switch base 22 is moved by 12 which is on the outside of 1. Also, 22 is attached to switch arm 23 on the inside of invention. Depending on the setting of 12, 23 may or may not be interlocked with 18. The interior of the invention also contains hook main 24 and hook side 25. 24 and 25 allow for the drawstring 9 to be separated into 16 and 17 which attach to 18 and 19 respectively. Lastly, are the locking pillars 26 which are the various sizes which the invention can be set at when 20 and 12 are in the correct setting.

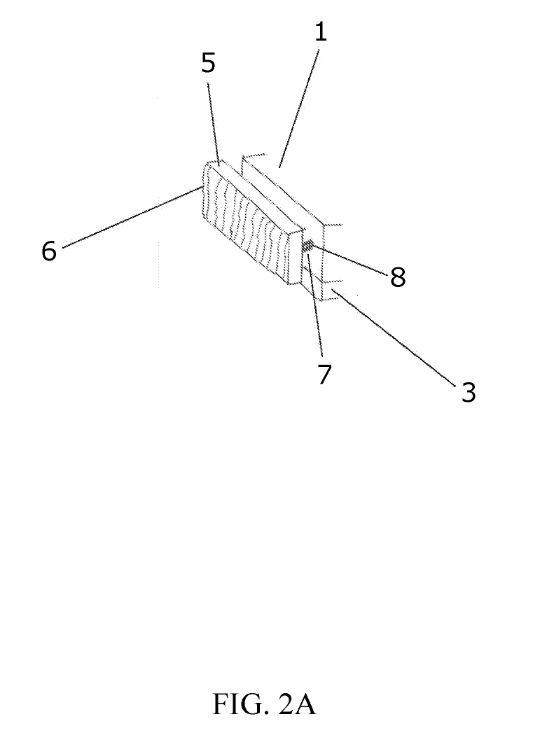

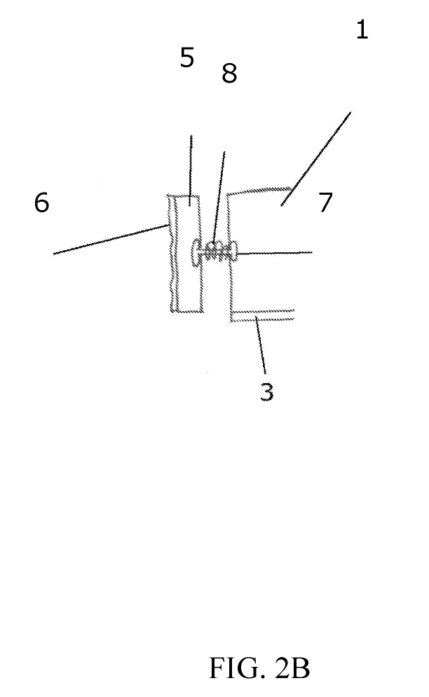

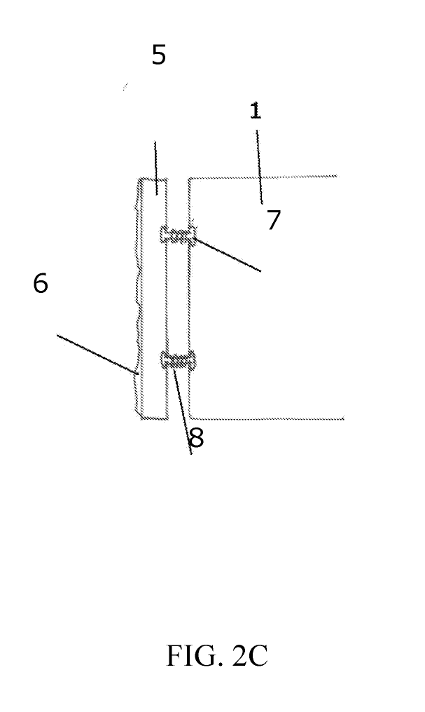

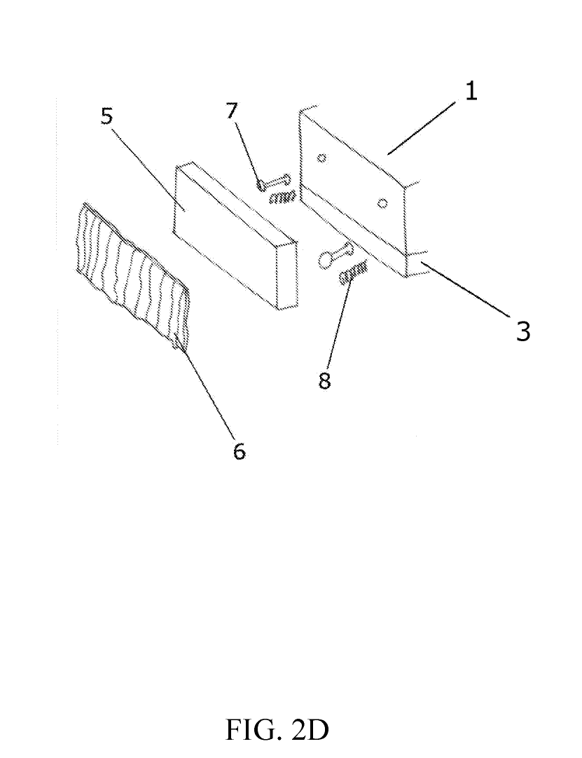

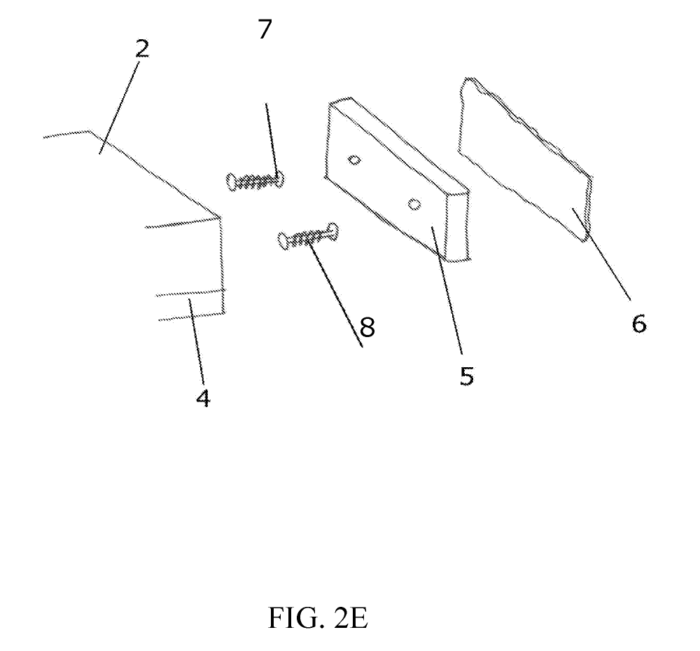

FIG. 2 A-E: These drawings contain various perspective on the cushions attached to the frame mount. FIG. 2D shows 6 which will be attached to the outside of 5 to prevent scratching the interior of the window. 5 and 1 contain holes which allow for 7 to stay fixed in place. 8 is wrapped around 7 to create pressure between 5 and 1 which is necessary for the invention to stay mounted without the need of screws or other manually installed fixtures.

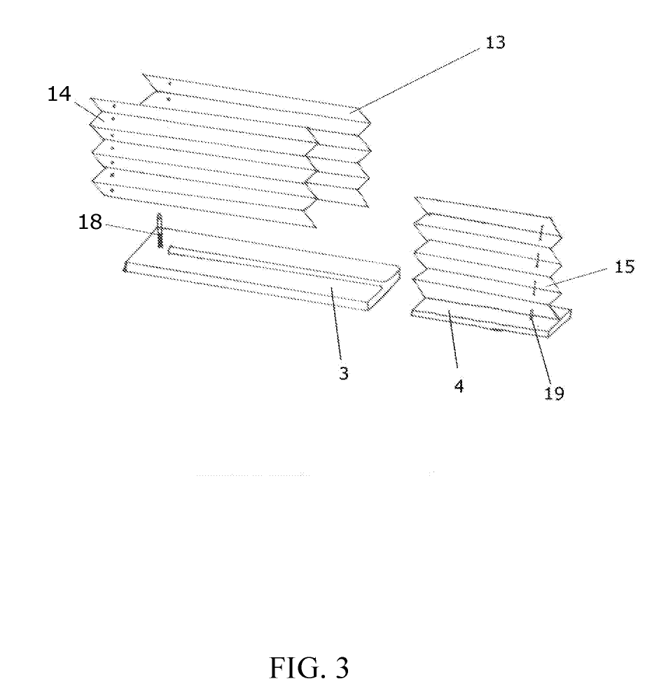

FIG. 3: This drawing further shows how exactly the shade material is positioned and overlaps one another. 13 and 14 are attached to 3 while 15 is attached to 4. 4 can move in and out of 3 while 15 can move in an out of 14 and 13 as well.

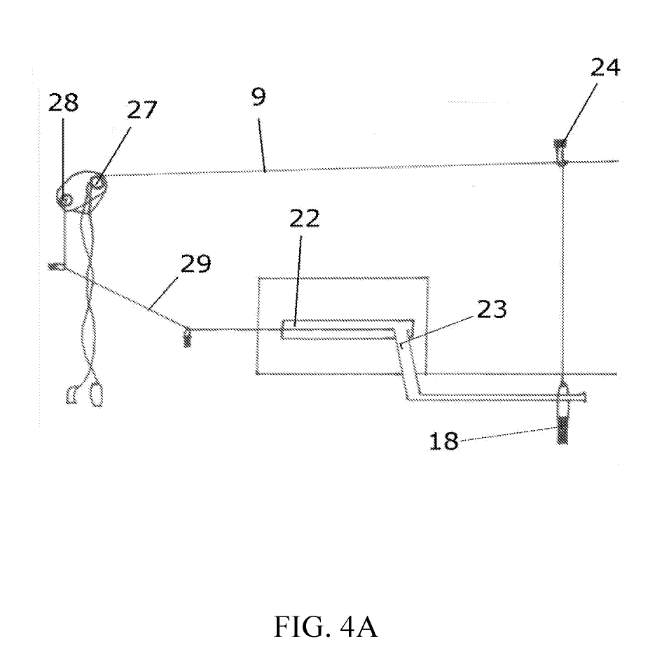

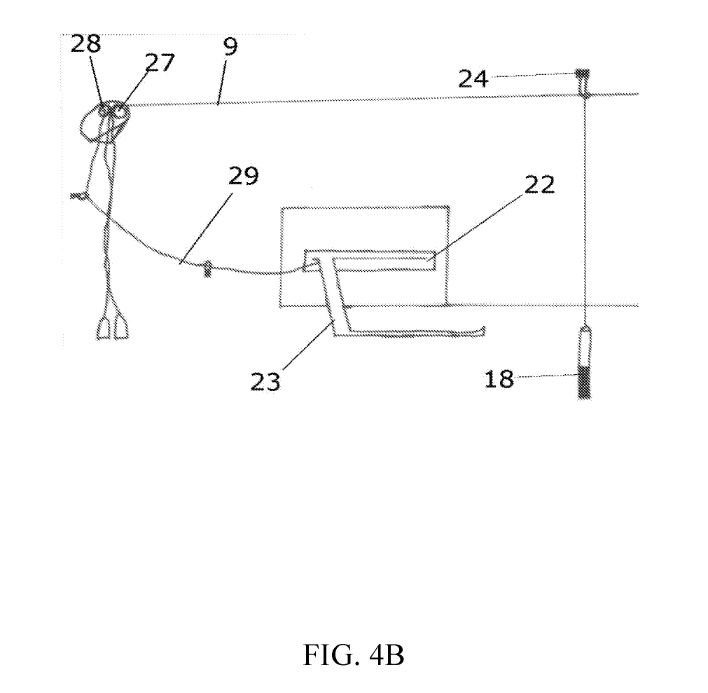

FIG. 4 A& B: FIG. 4A illustrates the 11 when in the locked position. When unlocked, the gear string 29 will tighten and this will pull the moveable gear 28 down away from the fixed gear 27 effectively opening the drawstring. Also, when unlocked, 22 will move 23 so that 23 will interlock with 18. This is what locks the base of the shade in place. The base of the shade must be locked in place to allow for the consumer to resize the shade to the appropriate size for their window. If the base was not locked gravity would pull the base downward when the drawstring was unlocked and the shade would become fully drawn all by itself. FIG. 4B illustrates the 11 in the unlocked position. When unlocked 29 is not tight which allows 28 to move freely which makes it function like a standard drawstring lock. Additionally, 23 is not interlocked with 18 and this allows for the consumer to use the drawstring to move the base and this determines how much of the shade is drawn.

FIG. 5: 12 is used to determine which direction the two-way needle 21 can move. When 12 is set to the unlocked position the needle can move outwards toward the moveable frame 2. This allows the consumer to extend 2 while doing this 21 will lock in-between the locking pillars 26 until the shade is fit to the desired size. Whereas, when 12 is set to locked 21 can move inwards towards the frame base 1. Due to this, there is nothing blocking the pillars and the consumer can retract the movable frame 2. This allows the user to reset the size of the invention.

The invention claimed is:

1. A window shade that can fit all sizes in a spectrum of window sizes.

2. The product in claim 1, wherein the shade can be resized from a smaller window to a larger window and from a larger window to a smaller window.

3. The product in claim 2, wherein the process of resizing does not require any screws, the installation of a mounting fixture or cutting/destruction of the original product material.
